(19) United States
(12) Patent Application Publication
(10) Pub. No.: US 2013/0180489 A1
(43) Pub. Date: Jul. 18, 2013

(54) PYROLYSIS OIL CONTAINING FUEL AND USE THEREOF, METHOD FOR PREPARING THE FUEL, INTERNAL COMBUSTION ENGINE SYSTEM AND METHOD FOR OPERATING THE SAME

(71) Applicant: Jens-Uwe Reeh, Flintbek (DE)

(72) Inventor: Jens-Uwe Reeh, Flintbek (DE)

(21) Appl. No.: 13/638,318

(22) PCT Filed: Apr. 1, 2010
(86) PCT No.: PCT/EP10/02114

§ 371 Date: Nov. 6, 2012

(51) Int. Cl. C10L 1/18; F02B 43/00

(52) U.S. Cl. CPC C10L 1/1802; F02B 43/00
USPC 123/1 A; 44/307

(57) ABSTRACT

The present disclosure refers to a fuel free of emulsifiers, wherein the fuel may be an emulsion of (a) at least one of a mineral oil, synthetic oil, or natural oil in (b) a pyrolysis oil with a percent weight ratio, (a):(b), of 1 to 15:99 to 85. The Sauter Mean Diameter of droplets of (a) in the emulsion may be 1 micrometer to 15 micrometers. An internal combustion engine system may comprise a reservoir for pyrolysis oil and a reservoir for at least one of a mineral oil, synthetic oil, or natural oil, and a homogenizer configured to provide an emulsion from said oils. The homogenizer may include an inlet connected with said reservoirs and an outlet. The system may also comprise an internal combustion engine which may include at least one combustion chamber, wherein the outlet of the homogenizer may be connected to the internal combustion engine.

### TECHNICAL FIELD

The present disclosure refers to a pyrolysis oil containing fuel and its use, and a method for preparing the pyrolysis oil containing fuel. Furthermore, the present disclosure refers to an internal combustion engine system and a method for operating the same.

### BACKGROUND

New fuels replacing fossil fuels are the subject of ongoing interest, in particular with respect to the replacement of diesel fuel or light fuel oil (LFO).

In view of the reduction of green house gas emissions that are believed to contribute to global warming, the selection of fuel types which are CO₂ neutral, is considered one of the most effective routes. This is the case for fuels manufactured from biomass, as biomass absorbs the same amount of CO₂ during its growing period as it releases when combusted as a fuel.

For example, esterified canola oil as well as alcohols and derivatives thereof have been proposed for this purpose. One specific example of such substitutes is a diesel fuel substitute, which is a microemulsion comprising about 70 to 99% alcohol-fatty acid esters, about 1 to 30% alcohol and less than 1% alkali metal soap (U.S. Pat. No. 5,380,343).

However, researchers particularly focus on liquid fuels obtained by the pyrolysis of biomass. Liquid biomass fuels can be obtained from the pyrolysis of, for example, wood or agricultural wastes, like straw, etc., and are commonly designated as pyrolysis oils. In general, pyrolysis oil is predominantly produced by the “Fast Pyrolysis” technology, which comprises rapid pyrolysation of biomass in a fluidized bubbling sand bed reactor, wherein the solid heat-carrying medium is circulated and, therefore, the residence time of solids is well-controlled and high heating rates (up to 1000° C./second) are obtained. The biomass feed and the solid heat-carrying medium are passed through a tubular transport reactor at a temperature in the range of about 450 to 500° C. and in a residence time of less than 1 second.

Typical compositions of two different pyrolysis oils are shown in the following Table 1 (according to Diebold et al. in: A. V. Bridgewater and D. G. B. Boocock (ed.), Developments in thermochemical biomass conversion, Glasgow, Blackie Academic & Professional, Vol. 1, p. 433-447).

TABLE 1
Properties of pyrolysis oils (wet oil basis)

| Feedstock (char removal | Poplar (hot- | Maple and oak (char |
|---|---|---|
| method) | gas filtered) | cyclone), heavy blend |
| Water, wt. % | 18.9 | 23.3 |
| Elemental | | |
| Carbon, wt. % | 46.5 | 44.8 |
| Hydrogen, wt. % | 7.2 | 7.2 |
| Oxygen, wt. % | 46.1 | 47.8 |
| Sulphur, wt. % | 0.02 | <0.01 |
| Nitrogen, wt. % | 0.15 | 0.1 |
| K + Na, ppm | 9.9 | 328 |
| Cl, ppm | 7.9 | 3 |
| Ash, wt % | 0.01 | 0.09 |
| Conradson carbon, wt. % | 14 | 20 |
| HHV, MJ/kg | 18.7 | 18.1 |
| LHV, MJ/kg | 17.4 | 16.6 |
| Density, kg/m³ | 1200 | 1230 |
| Flash point, ° C. | 64 | >106 |
| Pour point, ° C. | −36 | −9 |
| Viscosity at 50° C., cSt | 13.5 | 70 |
| Ethanol insoluble filtered | 0.045 | 0.3 |
| solids, wt. % | | |
| pH | 2.8 | 2.8 |

As can be seen from the above table, the physical properties and the chemical composition of pyrolysis oils differ significantly from those of diesel oil or LFO, in particular with respect to the high content of water and oxygen and with respect to the acidic pH value and the rather low heating value (HHV and LHV) of pyrolysis oils. Moreover, pyrolysis oils, which include polar hydrocarbons and large amounts of water, are almost immiscible with diesel fuels or light fuel oil, which consist mainly of saturated olefinic and aromatic hydrocarbons. Finally, pyrolysis oils have poor lubrication properties.

Therefore, considerable problems have been experienced when pure pyrolysis oils are used as a substitute for diesel fuels or light fuel oil. These problems comprise corrosion, wear due to the lack of lubrication and poor ignition properties.

Due to the above problems, several proposals for improving the properties of pyrolysis oil containing fuels have been made.

For example, U.S. Pat. No. 5,820,640 (U.S. '640) discloses a pyrolysis liquid-in-diesel oil microemulsion fuel comprising (a) diesel oil in an amount sufficient to form a continuous phase in the composition, (b) a pyrolysis liquid forming a discontinuous phase in the composition, said pyrolysis liquid being a liquid obtained by rapid pyrolysis of biomass, and (c) at least one emulsifier selected from nonionic hydrophilic surfactants with a HLB value between 4 and 18, derived from fatty acids and polyoxyethylene glycol, or fatty acids, sorbitol and polyoxyethylene or polyethoxylated alcohols with long aliphatic chains. According to said patent, the fuel compositions typically contain up to 50 wt. % of the pyrolysis liquid together with the diesel oil, and the emulsifier is typically present in an amount of at least 0.5 by weight of the fuel composition. The pyrolysis liquid-in-diesel oil microemulsion fuel according to U.S. '640 is said to have an excellent stability and physical properties similar to those of common diesel fuel.

EP 1 196 515 B1 (EP '515) discloses a pyrolysis oil containing fuel consisting of an emulsion of pyrolysis liquids and natural and/or mineral oils with emulsifiers and, optionally, co-emulsifiers capable of forming oil-in-water, bicontinuous or water-in-oil emulsions, wherein the definition of emulsion does not include microemulsion. The pyrolysis oil containing fuel may be represented by an oil-in-water emulsion having a bio-oil/mineral oil or natural oil ratio of 55 to 99% w/w. The pyrolysis oil containing fuel according to EP '515 is said to have an exceptionally high stability.

M. Ikura et al., Biomass and Bioenergy 24 (2003), p. 221-232, disclose a study on the emulsification of pyrolysis derived bio-oil in diesel fuel, wherein the bio-oil in diesel fuel emulsion contains bio-oil in a concentration of 10 to 30 wt. % and 1 to 5 wt. % of a surfactant. According to said study it is concluded that the corrosion of the tested bio-oil in diesel fuel emulsions is about half that of pure bio-oil.

R. Calabria et al., Experimental Thermal and Fluid Science 31 (2007), p. 413-420 disclose a study on combustion fundamentals of pyrolysis oil based fuels, wherein the pyrolysis oil based fuels used in the experimental part were produced by dispersing 30 wt. % of pyrolysis oil in 70 wt. % of commercial diesel oil using 1 wt. % of an emulsifier. According to said study it is concluded that the general combustion behaviour of emulsions is intermediate with respect to pure pyrolysis oil and commercial diesel oil.

Moreover, the above-described known emulsion fuels on the basis of pyrolysis oil have been used in several pilot projects regarding power generation with commercially available diesel engines and gas turbines.

As a result of said pilot projects it was noted that, although an improvement with respect to the use of pure pyrolysis oil was achieved by using emulsion fuels on the basis of pyrolysis oil, lowering the costs for the pyrolysis oil-based fuel and adapting the technology and material is still necessary with regard to the most critical components of an engine, like the injector needle and nozzle and the injection pump, due to the increased wear. A further remaining significant problem are the still insufficient ignition properties of known emulsion fuels on the basis of pyrolysis oil.

The present disclosure is directed, at least in part, to improving or overcoming one or more aspects of the related prior art.

### SUMMARY OF THE DISCLOSURE

According to a first aspect of the present disclosure, a pyrolysis oil containing fuel free of emulsifiers is provided, wherein the fuel may be an emulsion of (a) at least one mineral oil and/or synthetic oil and/or natural oil in (b) a pyrolysis oil in a ratio of (a):(b), in weight %, of, e.g., 1 to 15:99 to 85, optionally containing a lubricant, wherein the Sauter Mean Diameter (SMD) D₃₂ of droplets of (a) in the emulsion may be in a range of 1 μm to 15 μm.

In another aspect of the present disclosure, a method for preparing the above pyrolysis oil containing fuel is provided. The method may comprise the steps:

providing a mixture of (a) at least one mineral oil and/or synthetic oil and/or natural oil and (b) a pyrolysis oil in a ratio of (a):(b), in weight %, of, e.g., 1 to 15:99 to 85, and, optionally, a lubricant; and

treating the mixture with a homogenizer to form an emulsion, such that the Sauter Mean Diameter (SMD) D₃₂ of droplets of (a) in the emulsion may be in a range of 1 μm to 15 μm.

According to a further aspect of the present disclosure, the use of the above pyrolysis oil containing fuel in an internal combustion engine for operating the same by burning the pyrolysis oil containing fuel is provided.

In another aspect of the present disclosure, an internal combustion engine system is provided. The internal combustion engine may comprise:

a reservoir for pyrolysis oil;

reservoir for mineral oil and/or synthetic oil and/or natural oil;

a homogenizer configured to provide an emulsion from said pyrolysis oil and said mineral oil and/or synthetic oil and/or natural oil, the homogenizer including an inlet connected with said reservoirs and an outlet; and

an internal combustion engine including at least one combustion chamber, wherein the outlet of the homogenizer may be connected to the internal combustion engine for operating the same by burning the emulsion.

In another aspect of the present disclosure, a method for operating an internal combustion engine system is provided. The method may comprise the steps:

providing at least one internal combustion engine including at least one combustion chamber;

providing a homogenizer;

introducing (a) at least one mineral oil and/or synthetic oil and/or natural oil and (b) a pyrolysis oil in a ratio of (a):(b), in weight %, of, e.g., 1 to 15:99 to 85, and, optionally, a lubricant into the homogenizer;

operating the homogenizer to provide an emulsion of (a), (b) and, optionally, said lubricant, such that the Sauter Mean Diameter (SMD) D₃₂ of droplets of (a) in the emulsion may be in a range of e.g. 1 μm to 15 μm;

transferring the obtained emulsion from the homogenizer to the at least one internal combustion engine; and

burning the emulsion within the at least one combustion chamber.

Other features and aspects of this disclosure will be apparent from the following description, the accompanying drawing, and the claims.

### BRIEF DESCRIPTION OF THE DRAWING

FIG. 1 is a schematic block diagram of an internal combustion engine system according to an exemplary embodiment of the present disclosure.

### DETAILED DESCRIPTION

The following is a detailed description of exemplary embodiments of the present disclosure. The exemplary embodiments described therein and illustrated in the drawing figure are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

According to a first aspect of the present disclosure, a pyrolysis oil containing fuel free of emulsifiers is provided, wherein the fuel may be an emulsion of (a) at least one mineral oil and/or synthetic oil and/or natural oil in (b) a pyrolysis oil in a ratio of (a):(b), in weight %, of e.g., 1 to 15:99 to 85, optionally containing a lubricant, wherein the Sauter Mean Diameter (SMD) D₃₂ of droplets of (a) in the emulsion is in a range of, e.g., 1 μm to 15 μm.

An emulsion is a mixture of two or more immiscible liquids, wherein one liquid (the dispersed phase) is dispersed in the other (the continuous phase). Emulsions are classified in water-in-oil emulsions and oil-in-water emulsion, depending on the volume fraction of both phases and on the type of emulsifier used. The present pyrolysis oil containing fuel may be an oil-in-water emulsion of a dispersion of at least one mineral oil and/or synthetic oil and/or natural oil in a continuous phase of a pyrolysis oil, since the amount of the at least one mineral oil and/or synthetic oil and/or natural oil in the fuel may be defined to be rather low.

An emulsifier may be defined to be a substance which stabilizes an emulsion by increasing its kinetic stability. The term “emulsifier” as used in the present description and in the appended claims may cover any substance known in the art usable as emulsifier, dispersant or surfactant. For example, emulsifiers used in the above-discussed prior art include alkylphenyl polyethylene glycol ethers, polyethylene polyoxypropylene glycol, rosin acid esters of polyoxyethylene glycol, alkylphenyl polyethoxy alkanols, fatty acid esters of sorbitan, alkoxylated fatty acid esters of sorbitan, N-alkyl trimethylene diamine oleate, octakis-(2-hydroxy propyl)-sucrose, condensation products of fatty acid amides and ethylene oxide, ethoxylated fatty alcohols, polyoxyethylene monostearate, polyoxyethylene monolaurate, propylene glycol monooleate, glycerol monostearate, ethanolamine fatty acid salts, stearyl dimethyl benzene ammonium chloride, various gums, such as gum tragacanth, gum acacia, etc.

It may be a feature of the present pyrolysis oil containing fuel that it is free of emulsifiers. In contrast, as indicated above, prior art pyrolysis oil containing fuel emulsions may include various amounts of emulsifiers, such that the present pyrolysis oil containing fuel can be provided at lower costs.

By adding the at least one mineral oil and/or synthetic oil and/or natural oil as a component of the above pyrolysis oil containing fuel, the pyrolysis oil containing fuel may be provided with the necessary ignition properties. Due to the composition of pyrolysis oil, as indicated above, it may be very difficult or almost impossible to ignite pure pyrolysis oil in a commercially available diesel engine. Therefore, it may be appropriate to add an ignition improver in order to improve the ignition properties of pyrolysis oil to a practically feasible level. In general, any oil providing pyrolysis oil with the necessary ignition properties may be be used as the above at least one mineral oil and/or synthetic oil and/or natural oil.

Specific examples of useful mineral oils are diesel oil, in particular according to DIN EN 590, ultra-low sulphur diesel and light fuel oil, in particular according to DIN 51603. A specific example of a synthetic oil is a synthetic diesel provided by the Gas-to-Liquids (GtL) technology, and specific examples of natural oils are rape methyl ester and soy methyl ester, which are the main ingredients of so called biodiesel. Said oils can be used per se or in the form of mixed oils.

The pyrolysis oil component in the pyrolysis oil containing fuel according to the first aspect of the present disclosure is not specifically restricted. In particular, suitable pyrolysis oils can be obtained from manufacturers like Dynamotive Energy Systems Corporation, Richmond, Canada (product: BioOil), Ensyn Corporation, Wilmington, Del. (product: Biooil provided by the Rapid Thermal Process (RTP)™) and Genting Group, Kuala Lumpur, Malaysia (product: GENTING Bio-Oil).

According to the first aspect of the present disclosure, the ratio of (a) the at least one mineral oil and/or synthetic oil and/or natural oil to (b) the pyrolysis oil, i.e. (a):(b), in weight %, may be in a range of 1 to 15:99 to 85. In case the ratio (a):(b) is less than 1:99, sufficient ignition properties of the present pyrolysis oil containing fuel cannot be secured. Further, in case the ratio (a):(b) is more than 15:85, one of the desired effects of the present pyrolysis oil containing fuel, i.e. to be an essentially CO₂ neutral fuel, may be not achieved.

According to an exemplary embodiment of the present disclosure, the ratio of (a):(b), in weight %, may be 2 to 14:98 to 86, preferably 3 to 13:97 to 87, preferably 4 to 12:96 to 88, preferably 5 to 11:95 to 89, preferably 6 to 10:94 to 90 and preferably 7 to 9:93 to 91. Further exemplary ratios (a):(b) are 4 to 8:96 to 92 and 5 to 7:95 to 93. Specifically exemplary ratios (a):(b) are 1:99, 2:98, 3:97, 4:96, 5:95, 6:94, 7:93, 8:92, 9:91, 10:90, 11:89, 12:88, 13:87, 14:86 and 15:85.

According to a preferred embodiment of the first aspect of the present disclosure, the pyrolysis oil containing fuel optionally may contain a lubricant. As mentioned above, pyrolysis oils may have poor lubrication properties. The lubrication properties may be improved by adding the at least one mineral oil and/or synthetic oil and/or natural oil according to the present disclosure. However, if said at least one oil is added in a rather low amount, like for example in an amount of 1 to 3% by weight, it may be necessary to additionally add a lubricant. A suitable lubricant is for example glycerine. The optional lubricant is usually added in an amount of 1 to 5% by weight, based on the total weight of (a) and (b).

According to the present disclosure, the droplet diameter of the droplets of the at least one mineral oil and/or synthetic oil and/or natural oil in the pyrolysis oil/mineral oil and/or synthetic oil and/or natural oil emulsion may be provided as Sauter Mean Diameter (SMD) D₃₂. The SMD expresses the fineness of emulsion droplets in terms of the surface area. In particular, the SMD may be the diameter of a droplet having the same volume-to-surface area as the total volume of all the droplets to the total surface area of all the droplets.

The measurement of the Sauter Mean Diameter (SMD) D₃₂ may be carried out as known in the art by a laser diffraction method, for example by an Insitec L instrument (available from Malvern Instruments GmbH, Herrenberg, Germany). It should be noted that according to the present application the Sauter Mean Diameter (SMD) D₃₂ may be the SMD of droplets of (a) present in an emulsion immediately after leaving the homogenizer, which is described further below.

According to the present disclosure, the Sauter Mean Diameter (SMD) D₃₂ of droplets of (a) in the emulsion is in a range of 1 μm to 15 μm. In case the Sauter Mean Diameter (SMD) D₃₂ of droplets of (a) in the emulsion is outside the above range, advantageous ignition properties of the pyrolysis oil containing fuel are difficult to achieve, and furthermore, lubrication and corrosion problems may be enhanced. According to a preferred embodiment of the first aspect of the present disclosure, the Sauter Mean Diameter (SMD) D₃₂ of droplets of (a) in the emulsion may be in a range of 2 μm to 14 μm, preferably 3 μm to 13 μm, preferably 4 μm to 12 μm, preferably 5 μm to 11 μm, preferably 6 μm to 10 μm, preferably 7 μm to 9 μm. Further preferred ranges of the Sauter Mean Diameter (SMD) D₃₂ of (a) are 2 μm to 10 μm, 3 μm to 5 μm and 3 μm to 4 μm.

According to a second aspect of the present disclosure, a method for preparing the above pyrolysis oil containing fuel of the above-described first aspect is provided, may comprise the steps providing a mixture of (a) at least one mineral oil and/or synthetic oil and/or natural oil and (b) a pyrolysis oil in a ratio of (a):(b), in weight %, of 1 to 15:99 to 85, and, optionally, a lubricant, and treating the mixture with a homogenizer to form an emulsion, such that the Sauter Mean Diameter (SMD) D₃₂ of droplets of (a) in the emulsion is in a range of 1 μm to 15 μm.

According to the second aspect of the present disclosure, a mixture of (a) at least one mineral oil and/or synthetic oil and/or natural oil and (b) a pyrolysis oil in a ratio of (a):(b), in weight %, of 1 to 15:99 to 85, and, optionally, a lubricant is provided.

The process step of forming the mixture of the components (a) and (b) of the pyrolysis oil containing fuel is not specifically restricted. Thus, the components (a) and (b) can be mixed in advance, i.e. before introducing the components (a) and (b) into the homogenizer, which is described further below, for example in a suitable mixing vessel provided with a stirrer or any other known agitation means. Further, the components (a) and (b) can be mixed after feeding the components (a) and (b) into the homogenizer, i.e. by the homogenizing process per se. In view of the costs, it is generally preferred that the components (a) and (b) are mixed within the homogenizer.

The process step of treating the mixture with a homogenizer to form an emulsion is not specifically restricted, as long as it can provide an emulsion having a Sauter Mean Diameter (SMD) D₃₂ of droplets of (a) in the emulsion in a range of 1 μm to 15 μm.

Suitable homogenizers for carrying out the above process step of treating the mixture with a homogenizer are dynamic rotor-stator homogenizers, which consist of concentric tool rings that are radially slotted and/or drilled. The annular shearing gap of such dynamic rotor-stator homogenizers is generally 1 mm or less. Such dynamic rotor-stator homogenizers are available, for example, from BWS Technology GmbH, Grevenbroich, Germany (type: Supraton® High shear in-line Homogenizers). The Sauter Mean Diameter (SMD) D₃₂ of droplets of (a) in the emulsion obtained by such a dynamic rotor-stator homogenizer can be controlled by adjusting the annular shearing gap to an appropriate value, for example of 0.1 to 0.8 mm.

According to a third aspect of the present disclosure, the use of the pyrolysis oil containing fuel according to the first aspect in an internal combustion engine is provided.

The term “internal combustion engine” as used herein is not specifically restricted and comprises any engine, in which the combustion of a fuel occurs with an oxidizer to produce high temperature and pressure gases, which are directly applied to a movable component of the engine, such as pistons or turbine blades, and move it over a distance thereby generating mechanical energy. Thus, as used herein, the term “internal combustion engine” comprises piston engines and turbines, which can be operated with pyrolysis oil containing fuel according to the first aspect. Said internal combustion engine may be stationary and, for example, used for power generation, or mobile and, for example, used in vehicles and ships. Preferably, internal combustion engines, wherein the pyrolysis oil containing fuel according to the first aspect can be used, are internal combustion engines commonly operated with diesel fuel or light fuel oil. Examples of such engines are medium speed internal combustion diesel engines, like for example inline and V-type engines of the series M20, M25, M32, M43 manufactured by Caterpillar Motoren GmbH & Co. Kg, Kiel, Germany, operated in an rpm range of 500 to 1000.

According to a fourth aspect of the present disclosure, an internal combustion engine system is provided, which may comprise a reservoir for pyrolysis oil, a reservoir for mineral oil and/or synthetic oil and/or natural oil, a homogenizer configured to provide an emulsion from said pyrolysis oil and said mineral oil and/or synthetic oil and/or natural oil, the homogenizer including an inlet connected with said reservoirs and an outlet, and at least one internal combustion engine including, e.g. at least one fuel injection pump and at least one combustion chamber, wherein the outlet of the homogenizer is connected with the at least one fuel injection pump.

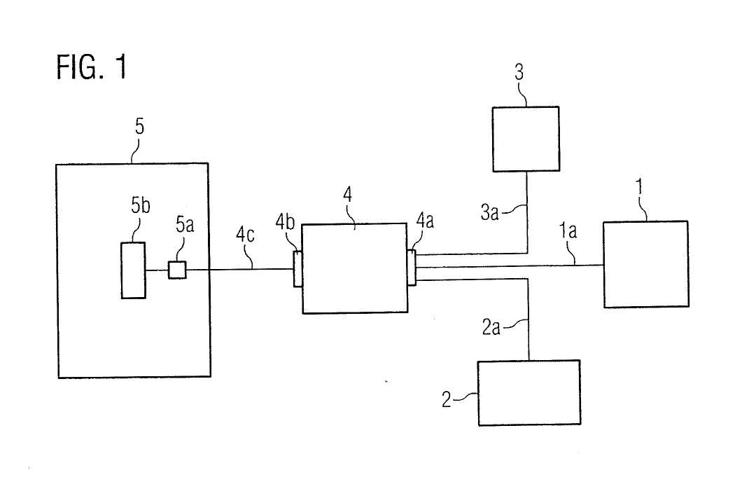

The definitions of the pyrolysis oil, the mineral oil and/or synthetic oil and/or natural oil, the homogenizer and the internal combustion engine provided above also apply with respect to the fourth aspect of the present disclosure. In particular, a non-limiting example of an internal combustion engine system according to the fourth aspect of the present disclosure is shown in FIG. 1.

According to FIG. 1, the internal combustion engine system includes a reservoir 1 for pyrolysis oil, a reservoir 2 for mineral oil and/or synthetic oil and/or natural oil, optionally a reservoir 3 for a lubricant, a homogenizer 4 and an internal combustion engine 5.

Suitable reservoirs for pyrolysis oil, mineral oil and/or synthetic oil and/or natural oil and a lubricant 1, 2 and 3, as well as the design of corresponding lines 1a, 2a and 3a connecting said reservoirs with the homogenizer 4, are well known to the skilled person, such that a description thereof is omitted.

The homogenizer 4 as described above has an inlet 4a connected with said reservoirs 1, 2 and, optionally, 3, by said lines 1a, 2a and, optionally, 3a, respectively, and an outlet 4b.

The engine 5 includes at least one fuel injection pump 5a and at least one combustion chamber 5b, wherein the outlet 4b of the homogenizer 4 is connected with the at least one fuel injection pump 5a by at least one line 4c. Of course, the number of fuel injection pumps 5a and combustion chambers 5b of the engine 5 is not specifically restricted and it may be any number present in commercially available internal combustion engines suitable for the use with the pyrolysis oil containing fuel of the first aspect of the present disclosure.

According to a fifth aspect of the present disclosure, a method for operating an internal combustion engine system is provided, comprising the steps:

providing an internal combustion engine 5 including at least one fuel injection pump 5a and at least one combustion chamber 5b,

providing a homogenizer 4,

introducing (a) at least one mineral oil and/or synthetic oil and/or natural oil and (b) a pyrolysis oil in a ratio of (a):(b), in weight %, of 1 to 15:99 to 85, and, optionally, a lubricant into the homogenizer 4,

operating the homogenizer 4 to provide an emulsion of (a), (b) and, optionally, said lubricant, such that the Sauter Mean Diameter (SMD) D₃₂ of droplets of (a) in the emulsion is in a range of 1 μm to 15 μm,

transferring the obtained emulsion from the homogenizer 4 to the at least one fuel injection pump 5a,

injecting the emulsion via the at least one fuel injection pump 5a into the at least one combustion chamber 5b, and

igniting the injected emulsion within the at least one combustion chamber 5b.

The definitions of the pyrolysis oil, the mineral oil and/or synthetic oil and/or natural oil, the homogenizer, the internal combustion engine and the internal combustion engine system provided above also apply with respect to the fifth aspect of the present disclosure.

The above steps of introducing (a) at least one mineral oil and/or synthetic oil and/or natural oil and (b) a pyrolysis oil in a ratio of (a):(b), in weight %, of 1 to 15:99 to 85, and, optionally, a lubricant into the inlet 4a of the homogenizer 4, and operating the homogenizer 4 to provide an emulsion of (a), (b) and, optionally, said lubricant, such that the Sauter Mean Diameter (SMD) D₃₂ of droplets of (a) in the emulsion is in a range of 1 μm to 15 μm, are not specifically restricted, as long as the required emulsion is generated by the homogenizer 4. Therefore, the skilled person is able to select suitable parameters for feeding the at least one mineral oil and/or synthetic oil and/or natural oil, the pyrolysis oil, and, optionally, the lubricant, and for operating the homogenizer, for example by selecting an appropriate speed and annular shearing gap, in order to provide an emulsion with the required properties.

Furthermore, the above steps of injecting the emulsion via the at least one fuel injection pump 5a into the at least one combustion chamber 5b, and igniting the injected emulsion within the at least one combustion chamber 5b and the engine are not specifically restricted, as long as the engine provides the expected power output and overall performance.

However, the above step of transferring the obtained emulsion from the outlet 4b of the homogenizer 4 to the at least one fuel injection pump 5a has to be carried out such that the properties of the emulsion leaving the outlet 4a of the homogenizer 4 are maintained to the highest possible extent, until the emulsion arrives at, and is fed into, the at least one fuel injection pump 5a. Maintaining the properties of the emulsion to the highest possible extend specifically means that the Sauter Mean Diameter (SMD) D₃₂ of droplets of (a) in the emulsion, which, according to the present disclosure, is in a range of 1 μm to 15 μm, is not essentially enlarged (i.e. such that the respective upper limit of the SMD D₃₂ is not exceeded by more than 10%) on the way of the emulsion from the outlet 4a of the homogenizer 4 to the at least one fuel injection pump 5a. Otherwise, the ignition properties of the pyrolysis oil containing fuel will be worsened and an advantageous operation of the engine cannot be assured.

Thus, it is an essential feature of the method for operating the internal combustion engine system according to the present disclosure that the time period for the transfer of the emulsion from the outlet 4b of the homogenizer 4 to the at least one fuel injection pump 5a is as short as possible. Therefore, according to a preferred embodiment of the fifth aspect, said time period is in a range of 0.1 seconds to 10 seconds, more preferred in a range of 0.1 seconds to 5 seconds.

In order to assure that the time period for the transfer of the emulsion from the outlet 4b of the homogenizer 4 to the at least one fuel injection pump 5a is as short as possible, the homogenizer 4 should be arranged as close as possible to the internal combustion engine 5, as schematically indicated in FIG. 1. In order to further accelerate the flow of the emulsion leaving the outlet 4b of the homogenizer 4, fluid pumps (not shown in FIG. 1) may be provided at an appropriate location according to the general knowledge of the skilled person, preferably in the line 4c connecting the homogenizer 4 with the at least one fuel injection pump 5a.

### INDUSTRIAL APPLICABILITY

In the following, the basic operation of the above exemplary embodiments of the present disclosure is explained, wherein it is referred to FIG. 1, as appropriate.

### EXAMPLE

Operating an internal combustion engine system according to the present disclosure with a pyrolysis oil containing fuel according to the present disclosure

The raw materials for producing the pyrolysis oil containing fuel were as follows:

Mineral oil: Diesel fuel according to DIN EN 590
Pyrolysis oil: BioOil (supplied by Dynamotive Energy Systems Corporation, Richmond, Canada)

### Lubricant: Glycerine

The diesel oil, the pyrolysis oil and the lubricant were supplied to a Supraton® S200.7 homogenizer (supplied by BWS Technology GmbH, Grevenbroich, Germany) via corresponding lines from respective reservoirs in such amounts that the ratio of the mineral oil to the pyrolysis oil was 5:95, in weight %, and the ratio of the lubricant was 1.5% by weight, based on the combined amount of mineral oil and pyrolysis oil. The Supraton® S200.7 homogenizer was operated with an annular shearing gap of 0.4 mm and a rotor speed of 5000 rpm. The droplet size of the mineral oil droplets in the emulsion leaving the homogenizer was measured with an Insitec L (available from Malvern Instruments GmbH, Herrenberg, Germany). It was found that the Sauter Mean Diameter (SMD) D₃₂ of the mineral oil droplets in the emulsion was 3.6

The outlet of the Supraton® S200.7 homogenizer was coupled with a medium speed diesel engine (supplied by Caterpillar Motoren GmbH & Co., KG, Kiel, Germany), such that the emulsion leaving the homogenizer was fed into the fuel injection pump of the engine. The length of the lines for feeding the emulsion from the Supraton® S200.7 homogenizer to the fuel injection pump of the engine and the flow speed of the emulsion were selected such that the time period for the transfer of the emulsion from the outlet of the homogenizer to the fuel injection pump was approximately 0.6 seconds. The droplet size of the mineral oil droplets in the emulsion shortly before entering the fuel injection pump was also measured with the Institec L. It was found that the Sauter Mean Diameter (SMD) D₃₂ of the mineral oil droplets in the emulsion increased only slightly to 3.8 μm.

The emulsion was then injected via the fuel injection pump into the combustion chamber of the engine and the engine was operated at a speed of 1500 rpm. No problems with respect to the ignition of the fuel occurred and the power output of the engine was comparable to the operation with diesel oil according to DIN EN 590.

Although the preferred embodiments of this invention have been described herein, improvements and modifications may be incorporated without departing from the scope of the following claims.

1. A fuel tree of emulsifiers, comprising:
an emulsion of:
(a) at least one of a mineral oil, a synthetic oil, or a natural oil, and
(b) a pyrolysis oil;
the emulsion comprising a ratio of (a):(b), in percent weight, of 1 to 15:99 to 85, wherein a Sauter Mean Diameter (SMD) of droplets of (a) in the emulsion is in a range of 1 micrometer to 15 micrometers.

2. The fuel of claim 1, wherein the mineral oil is a mineral based diesel oil, the synthetic oil is a synthetic diesel oil, and the natural oil is a biodiesel.

3. The fuel of claim 1, wherein the ratio of (a):(b), in percent weight %, is 3 to 13:97 to 87.

4. The fuel of claim 1, wherein the SMD of droplets of (a) in the emulsion is in a range of 2 micrometers to 10 micrometers

5. (canceled)

6. (canceled)

7. (canceled)

8. An internal combustion engine system, comprising:
a reservoir for pyrolysis oil;
a reservoir for at least one of a mineral oil, a synthetic oil, or a natural oil;
a homogenizer configured to provide an emulsion from the pyrolysis oil and the at least one oil, the homogenizer including an inlet connected with the reservoirs and an outlet; and
at least one internal combustion engine including at least one combustion chamber, wherein the outlet of the homogenizer is connected with the at least one internal combustion engine.

9. The internal combustion engine system of claim 8, further including a reservoir for a lubricant, the reservoir being connected with the inlet of the homogenizer.

10. The internal combustion engine system of claim 8, wherein the homogenizer is a dynamic rotor-stator homogenizer having an annular shearing gap.

11. The internal combustion engine system of claim 10, wherein the annular shearing gap of the dynamic rotor-stator homogenizer is 1 millimeter or less.

12. A method for operating an internal combustion engine system including at least one internal combustion engine with at least one combustion chamber and a homogenizer, comprising the steps of:
introducing into the homogenizer:
(a) at least one of a mineral oil, a and/or synthetic oil, or a and/or natural oil, and
(b) a pyrolysis oil, wherein
a ratio of (a):(b) is, in percent weight, of 1 to 15:99 to 85;
operating the homogenizer to provide an emulsion of (a) and (b), such that a Sauter Mean Diameter (SMD) of droplets of (a) in the emulsion is in a range of 1 micrometer to 15 micrometers; and
burning the emulsion within the at least one combustion chamber.

13. (canceled)

14. The method of claim 12, further comprising:
transferring the obtained emulsion from the homogenizer to at least one fuel injection pump and injecting the emulsion into the at least one combustion chamber.

15. The method of claim 14, wherein a time period for the transfer of the emulsion from the homogenizer to the at least one fuel injection pump is in a range of 0.1 seconds to 10 seconds

16. The fuel of claim 1, wherein the emulsion contains a lubricant.

17. The fuel of claim 16, wherein the lubricant is glycerine.

18. The fuel of claim 3, wherein the ratio of (a):(b), in percent weight, is 5 to 7:95 to 93.

19. The fuel of claim 1, wherein the at least one oil includes a mineral oil, a synthetic oil, and a natural oil.

20. The fuel of claim 4, wherein the SMD of droplets of (a) in the emulsion is in a range of 3 micrometers to 5 micrometers.

21. The internal combustion engine system of claim 10, wherein the annular shearing gap of the dynamic rotor-stator homogenizer is 0.1 millimeters to 0.8 millimeters.

22. The method of claim 15, wherein a time period for the transfer of the emulsion from the homogenizer to the at least one fuel injection pump is in a range of 0.1 seconds to 5 seconds.

23. The method of claim 12, further including introducing a lubricant into the homogenizer.

24. The method of claim 12, wherein the mineral oil is a mineral based diesel oil, the synthetic oil is a synthetic diesel oil, and the natural oil is a biodiesel.
